(19) United States
(12) Patent Application Publication
(10) Pub. No.: US 2026/0163175 A1
(43) Pub. Date: Jun. 11, 2026

(54) BATTERY PACK AND VEHICLE INCLUDING THE SAME

(71) Applicant: LG Energy Solution, Ltd., Seoul (KR)

(72) Inventors: Jae Wook KIM, Daejeon (KR); Je Hwan SHIN, Daejeon (KR); Suhyeong LEE, Daejeon (KR)

(73) Assignee: LG Energy Solution, Ltd., Seoul (KR)

(21) Appl. No.: 19/336,307

(22) Filed: Sep. 22, 2025

(30) Foreign Application Priority Data
Oct. 4, 2024 (KR) 10-2024-0134994

(51) Int. Cl. H01M 50/30; B60L 50/64; H01M 10/613; H01M 10/625; H01M 10/647; H01M 10/6556; H01M 50/211; H01M 50/249; H01M 50/271; H01M 50/358

(52) U.S. Cl. CPC H01M 50/394; H01M 10/613; H01M 10/625; H01M 10/647; H01M 10/6556; H01M 50/211; H01M 50/249; H01M 50/271; H01M 50/358; B60L 50/64; H01M 2220/20

(57) ABSTRACT

A battery pack according to the present disclosure includes: a battery cell; a battery module including a module frame configured to have one side open and to accommodate the battery cell, and a cover plate configured to cover the open side of the module frame; and a pack frame including a battery module accommodation portion into which the battery module is inserted and configured to accommodate the battery module.

### CROSS REFERENCES TO RELATED APPLICATIONS

This application is based on and claims priority from Korean Patent Application No. 10-2024-0134994, filed on Oct. 4, 2024, with the Korean Intellectual Property Office, the disclosure of which is incorporated herein in its entirety by reference.

### TECHNICAL FIELD

The present disclosure relates to a battery pack and a vehicle including the same.

### BACKGROUND

As the demand for portable electronic products such as laptops, video cameras, and mobile phones has increased rapidly and the commercialization of robots and electric vehicles has become full-scale, research on high-performance secondary batteries capable of repeated charging and discharging is being conducted actively.

Currently, commercially available secondary batteries include nickel-cadmium batteries, nickel-hydrogen batteries, nickel-zinc batteries, and lithium secondary batteries. Among these, lithium secondary batteries are attracting attention because, compared to nickel-based secondary batteries, these lithium secondary batteries are free from the so-called memory effect, a phenomenon in which the chargeable capacity of a battery decreases when the battery is charged without being fully discharged, allowing a free charging and discharging. Lithium secondary batteries also have a very low self-discharge rate and high energy density.

Such lithium secondary batteries mainly use lithium-based oxides and carbon materials as positive and negative active materials, respectively. A lithium secondary battery includes an electrode assembly in which a positive electrode plate and a negative electrode plate are respectively coated with the positive and negative active materials, and are disposed with a separator interposed therebetween. The lithium secondary battery also includes an exterior material such as, for example, a battery case, that seals and accommodates the electrode assembly together with an electrolyte.

In general, depending on the shape of the outer packaging material, lithium secondary batteries may be classified into can-type secondary batteries, in which an electrode assembly is built into a metal can, and pouch-type secondary batteries, in which an electrode assembly is built into a pouch of an aluminum laminate sheet.

Recently, secondary batteries have been widely used for driving or energy storage not only in small devices such as portable electronic devices but also in medium and large devices such as electric vehicles and energy storage systems (ESS). Such secondary batteries may be accommodated together in a module case in a state of being electrically connected to each other to constitute a battery module, and the battery modules may be electrically reconnected in a limited space in order to increase energy density, thereby constituting a battery pack.

### SUMMARY

The present disclosure provides a battery pack configured to vent the gas downward.

A battery pack according to an embodiment of the present disclosure may include: a battery cell; a battery module including a module frame configured to have one side open and to accommodate the battery cell, and a cover plate configured to cover the open side of the module frame; and a pack frame including a battery module accommodation portion into which the battery module is inserted and configured to accommodate the battery module.

The pack frame may include a first tray having the battery module accommodation portion and a second tray disposed apart from the first tray and the battery module.

The first tray may further include a reinforcement portion extending from the battery module accommodation portion toward the second tray and configured to support a side surface of the cover plate.

A venting path configured to allow gas generated from the battery cell to flow may be provided between the first tray and the second tray.

The second tray may include a support pillar protruding toward the first tray on a surface facing the first tray. The support pillar is configured to support a lower surface of the cover plate.

The support pillars may support a corner portion of the cover plate.

The cover plate may include an insertion portion inserted into the battery module accommodation portion of the pack frame, and a support portion extending from the insertion portion and configured to be engaged with and supported on the pack frame.

An end portion of the open side of the module frame may be inserted into an inner surface of the insertion portion.

The module frame may include a base plate provided opposite to the cover plate and a plurality of side plates connected to the base plate and configured to cover side surfaces of the battery cells. The plurality of side plates includes two first side plates disposed opposite to each other and two second side plates disposed opposite to each other between the two first side plates. The two first side plates are coupled to the two second side plates through fastening members.

The battery pack may further include a heat sink disposed on a side opposite to the battery module accommodation portion with respect to the battery module.

The cover plate may include a vent hole configured to discharge gas generated from the battery cell.

A battery pack according to an embodiment of the present disclosure may include: a battery cell; a battery module configured to accommodate the battery cell and having a vent hole on one side surface; a first tray configured to define an opening to accommodate the battery module such that the opening is in communication with the vent hole of the battery module; and a second tray disposed apart from the first tray.

The vent hole of the battery module may be disposed to face a lower side of the battery pack.

A venting path configured to allow gas generated from the battery cell to flow may be provided between the first tray and the second tray.

A vehicle according to an embodiment of the present disclosure may include a battery pack according to the present disclosure.

A pack frame according to an embodiment of the present disclosure may include: a battery module accommodation portion configured to receive a battery module; a first tray provided with the battery module accommodation portion; and a second tray disposed apart from the first tray and the battery module.

The first tray may further include a reinforcement portion extending from the battery module accommodation portion toward the second tray and configured to support a side surface of the battery module.

A venting path configured to allow gas generated from the battery module to flow therethrough may be provided between the first tray and the second tray.

The second tray may include a support pillar protruding toward the first tray on a surface facing the first tray and configured to support a lower surface of the battery module.

The support pillar may support a corner portion of the lower surface of the battery module.

According to an aspect of the present disclosure, the gas venting direction of the battery module may be set toward a lower side. Without adding a separate venting device and/or member for forming a venting path, the gas venting direction may be set toward the lower side simply by providing the vent hole in the cover plate and covering a lower portion of the battery module with the cover plate. The weight of the battery module may be used to seal a space between the first tray and the second tray to enhance the sealing effect. Therefore, after the gas escapes through the vent hole, the gas may be effectively prevented or suppressed from escaping into the space between the cover plate and the first tray. For example, when the battery pack is mounted on a lower side of an electric vehicle, the gas is vented downward, thereby improving occupant safety.

According to another aspect of the present disclosure, with this configuration of the present disclosure, even without a separate member for fixing the battery module, the insertion portion of the cover plate may be inserted into the battery module accommodation portion, and the support portion of the cover plate may be engaged with and supported on the first tray, allowing the battery module to be fixedly seated in the pack frame. When the support pillar is provided, the battery module may be effectively seated in the pack frame. When a fastening member is coupled to the support pillar through a fixing portion, the battery module may be effectively fixed to the pack frame.

### BRIEF DESCRIPTION OF THE DRAWINGS

The following drawings attached to the present specification illustrate embodiments of the present disclosure and, together with the detailed description set forth below, serve to further aid in understanding the technical idea of the present disclosure. Therefore, the present disclosure should not be construed as being limited only to the matters illustrated in the drawings.

FIG. 1 is a view illustrating a battery pack according to an embodiment of the present disclosure in a partially disassembled state.

FIG. 2 is a perspective view of a battery pack including a battery module according to an embodiment of the present disclosure in an assembled state.

FIG. 3 is an exploded perspective view of the battery module included in the battery module according to an embodiment of the present disclosure.

FIG. 4 is a view illustrating a cover plate included in the battery module according to an embodiment of the present disclosure.

FIG. 5 is a view illustrating a module frame included in the battery module according to an embodiment of the present disclosure.

FIG. 6 is a view illustrating the module frame before assembly in the battery module according to an embodiment of the present disclosure.

FIG. 7 is a view illustrating the battery module seated on the pack frame according to an embodiment of the present disclosure.

FIG. 8 is a view illustrating a first tray included in the pack frame according to an embodiment of the present disclosure.

FIG. 9 is a view illustrating a second tray included in the pack frame according to an embodiment of the present disclosure.

FIG. 10 is a view illustrating a vehicle according to an embodiment of the present disclosure.

In some of the accompanying drawings, corresponding components are given the same reference numerals. A person ordinarily skilled in the art would appreciate that the drawings illustrate elements simply and clearly and are not necessarily drawn to scale. In addition, elements that are useful or essential in commercially implementable embodiments but are known in the art may often not be described in order to avoid impeding the understanding of the spirit of various embodiments of the present disclosure.

### DETAILED DESCRIPTION

Prior to describing the present disclosure in detail, the terms or words used in the specification and claims should not be construed as limited to their ordinary or dictionary meanings, but should be construed as having meanings and concepts consistent with the technical idea of the present disclosure based on the principle that an inventor may appropriately define the concepts of terms in order to explain his or her own invention in the best possible way. Accordingly, since the embodiments described in this description and the configurations illustrated in the drawings are merely some exemplary embodiments of the present disclosure, and do not represent all of the technical ideas of the present disclosure, it should be understood that various equivalents and modifications that could serve as alternatives to the embodiments may exist at the time of filing the present application.

The same reference numbers or symbols used in each drawing attached to this specification denote parts or components that perform substantially the same function. For the convenience of description and understanding, the same reference numbers or symbols may be used in different embodiments. In addition, even when components having the same reference numbers are illustrated in multiple drawings, it does not mean that all of the drawings represent a single embodiment.

In the following description, singular expressions are intended to include plural expressions unless the context clearly indicates otherwise. It should be understood that the terms such as “include” or “comprise” are intended to indicate the presence of features, numbers, steps, operations, components, parts, or combinations thereof described in the specification, and are not intended to exclude in advance the possibility of the presence or addition of one or more other features, numbers, steps, operations, components, parts, or combinations thereof.

In addition, terms such as upper, lower, top, bottom, side, front, and rear in the following description are expressed based on the direction illustrated in the drawings, and may be expressed differently if the direction of the subject changes.

In the specification and claims, terms including ordinals such as “first” and “second,” may be used to distinguish between components. These ordinals are used to distinguish between identical or similar components, and the use of these ordinals should not be interpreted as limiting the meaning of the terms. For example, components referred to with ordinals should not be interpreted in a restricted manner in terms of usage order or arrangement based on their numbers. If necessary, respective ordinals may be used interchangeably.

When multiple battery modules and/or battery cells are densely packed in a limited space, they may be vulnerable to accidents such as fire or explosion. For example, when a battery pack is used in an electric vehicle, in the event of a thermal event such as thermal runaway occurring inside the battery pack, setting the direction of venting paths for discharging gas is an important issue directly related to the safety of the electric vehicle and its occupants.

The present disclosure provides a battery pack configured to allow gas to be vented downward even when an event such as thermal runaway occurs in a battery cell.

Hereinafter, embodiments of the present disclosure will be described with reference to the accompanying drawings. However, the spirit of the present disclosure is not limited to the embodiments presented herein. For example, those ordinarily skilled in the art who understand the spirit of the present disclosure may propose other embodiments included within the scope of the spirit of the present disclosure through addition, modification, or deletion of components, and such embodiments shall also be deemed to fall within the scope of the present disclosure. For example, the shapes and sizes of elements in the drawings may be exaggerated for clearer description.

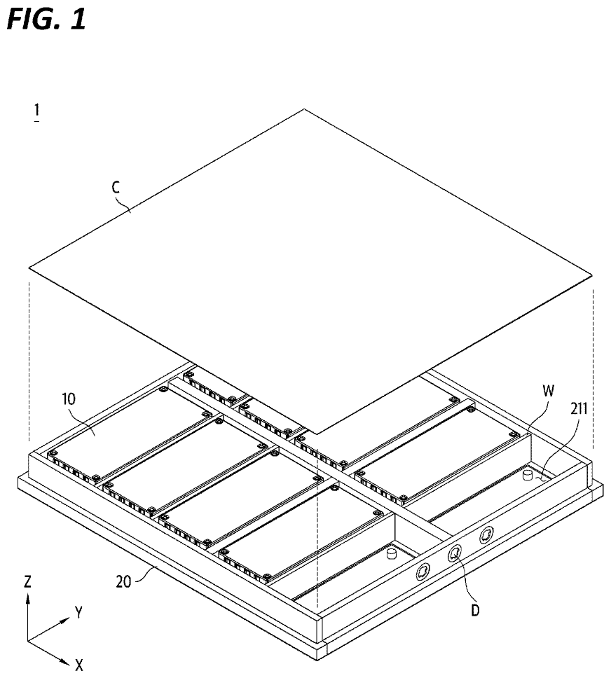

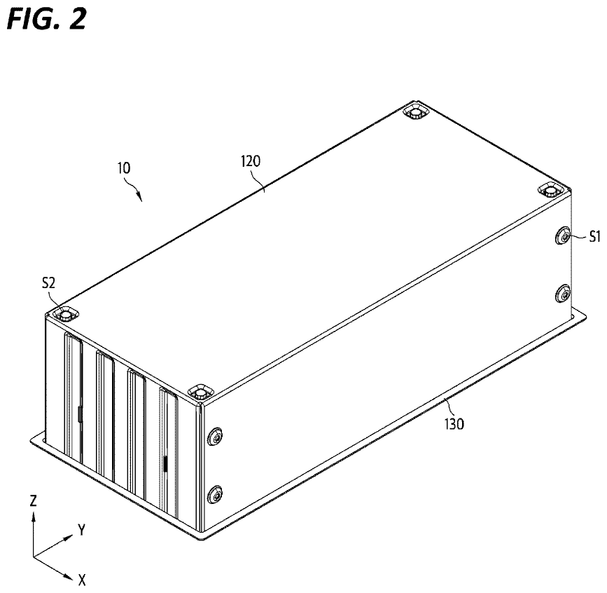

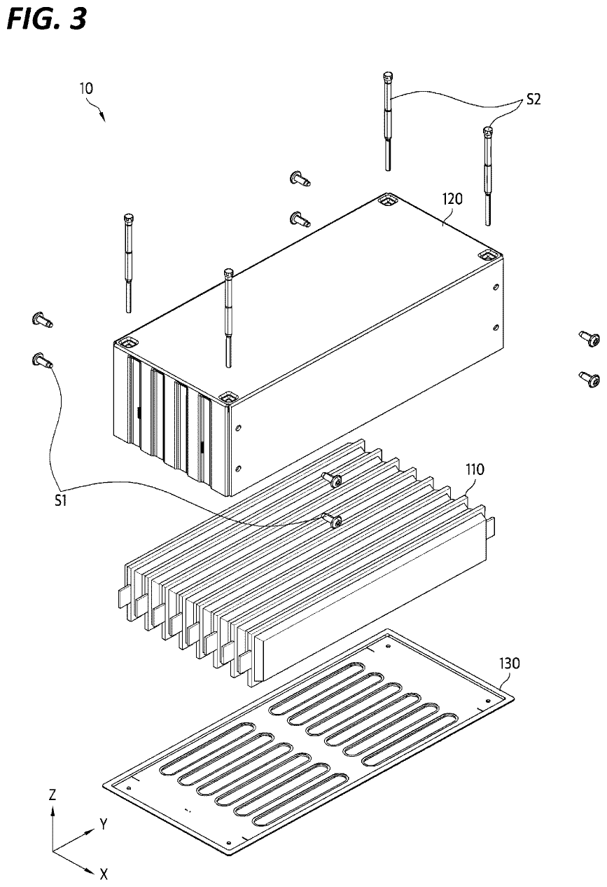

FIG. 1 is a view illustrating a battery pack 1 according to an embodiment of the present disclosure in a partially disassembled state. FIG. 2 is a perspective view illustrating a battery module 10 included in the battery pack 1 according to an embodiment of the present disclosure in an assembled state. FIG. 3 is an exploded perspective view illustrating a battery module 10 included in the battery pack 1 according to an embodiment of the present disclosure.

Referring to FIGS. 1 to 3, a battery pack 1 according to the present disclosure may include battery modules 10 and a pack frame 20.

The battery modules 10 may each include battery cells 110, a module frame 120, and a cover plate 130.

The battery cells 110 may be pouch-type battery cells. The battery cells 110 may include an electrode assembly, an electrolyte, and a pouch exterior material. A plurality of battery cells 110 may be stacked and arranged in one direction.

The module frame 120 may have one lateral side open. The module frame 120 may have a lower side open. The module frame 120 may be configured to accommodate the battery cells 110. The module frame 120 may be formed in a box shape with an open lower side to accommodate the battery cells 110 in an internal space. The cover plate 130 may cover the open side of the module frame 120. The module frame 120 may be inserted into an inner surface of the cover plate 130. The module frame 120 may be coupled to the cover plate 130 by being fitted into the inner surface of the cover plate 130. The cover plate 130 may include vent holes H configured to allow gas generated in the battery cells 110 to be discharged.

The pack frame 20 may include battery module accommodation portions 211, each configured to accommodate one of the battery modules 10. The battery module accommodation portions 211 may be openings. The battery module accommodation portions 211 may be configured to receive lower portions of the battery modules 10, respectively. The cover plates 130 of the battery modules 10 may be at least partially inserted into the battery module accommodation portions 211, respectively. The pack frame 20 may be configured to accommodate the battery modules 10. The pack frame 20 may include partition walls W that define accommodation spaces, each configured to accommodate one of the battery modules 10. The pack frame 20 may include a venting device D configured to discharge gas generated from the battery cells 110. The pack frame 20 may be in direct contact with module frames 120. For example, each of the module frames 120 may be directly accommodated in the pack frame 20 without an additional plate on an outer side thereof.

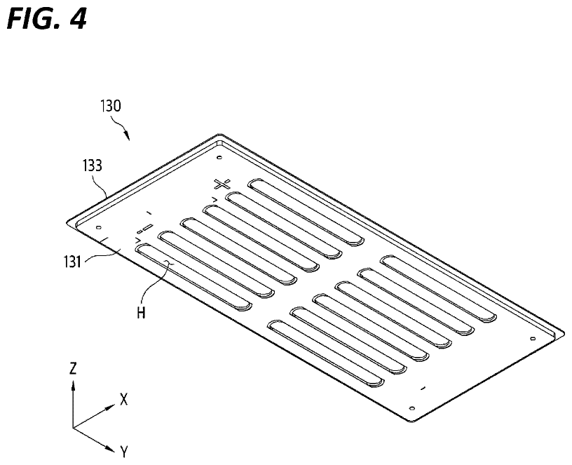

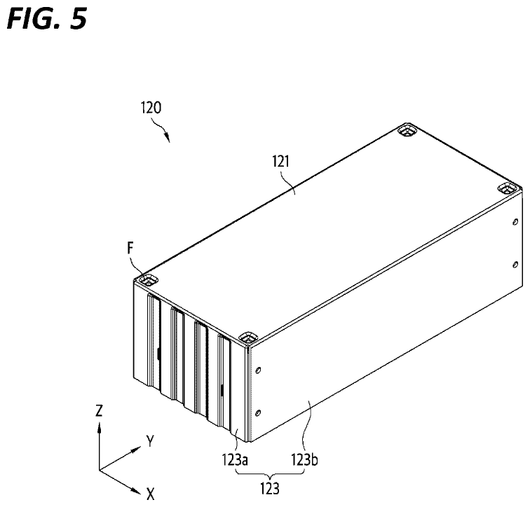

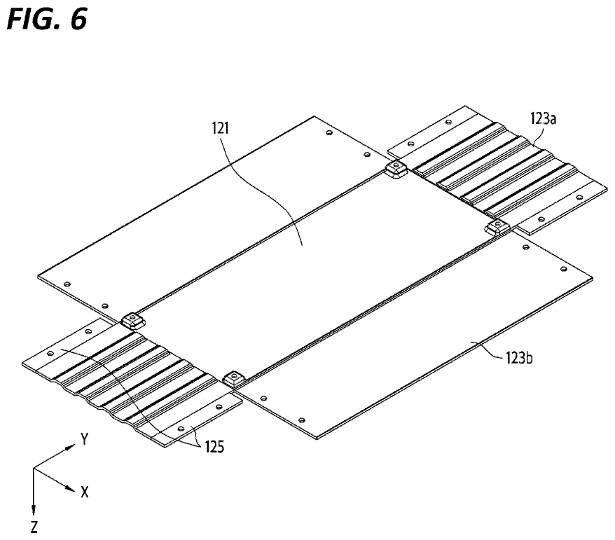

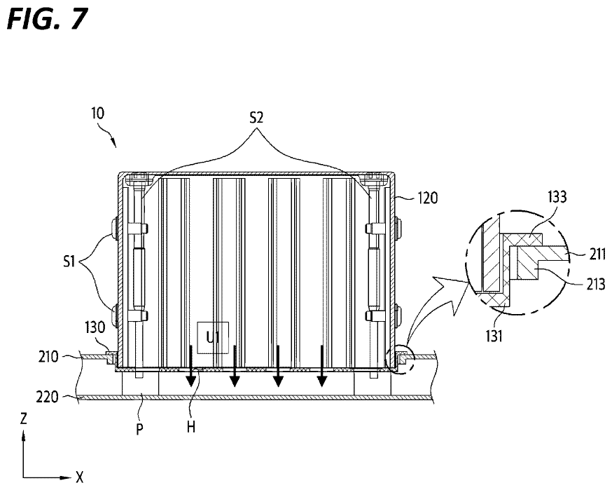

FIG. 4 is a view illustrating a cover plate 130 included in the battery module 10 according to an embodiment of the present disclosure. FIG. 5 is a view illustrating the module frame 120 included in the battery module 10 according to an embodiment of the present disclosure. FIG. 6 is a view illustrating the module frame 120 before assembly in the battery module 10 according to an embodiment of the present disclosure. FIG. 7 is a view illustrating the battery module 10 seated on the pack frame 20 according to an embodiment of the present disclosure.

Referring to FIGS. 4 to 7, the cover plate 130 may include an insertion portion 131 and a support portion 133.

The insertion portion 131 may be inserted into a battery module accommodation portion 211 of the pack frame 20. The area of a lower surface of the insertion portion 131 to be inserted into the battery module accommodation portion 211 may be smaller than an area of an opening of the battery module accommodation portion 211. An outer surface of the insertion portion 131 may contact a side surface of a first tray 210 of the pack frame 20, which will be described later. The support portion 133 may extend from the insertion portion 131. The extending direction of the support portion 133 may be perpendicular to an insertion direction of the battery module 10 into the pack frame 20. The support portion 133 may be engaged with and supported on the pack frame 20, such that the battery module 10 may be seated on or fixed to the first tray 210. A lower surface of the support portion 133 may contact an upper surface of the first tray 210 of the pack frame 20, which will described later. In a height direction (Z-axis extending direction), the position of the support portion 133 may correspond to an upper end of the insertion portion 131. The support portion 133 may be formed in a rectangular band shape around the insertion portion 131. The support portion 133 may be configured to seal a space between the first tray 210 and a second tray 220.

However, the types and shapes of the battery cells 110 and the corresponding components described above are not limited thereto. For example, the battery cells 110 may be any type of battery cell known prior to the filing of the present application, such as prismatic battery cells or cylindrical battery cells, and the same applies to the corresponding module frame 120, pack frame 20, cover plate 130, and components, which will be described later.

According to this configuration of the present disclosure, the gas venting direction of the battery pack 1 may be set toward the lower side (−Z-axis direction). Without adding separate venting devices and/or members for forming venting paths, the gas venting direction may be set to the lower direction simply by providing vent holes H in the cover plate 130 and covering the lower portion of the battery module 10 with the cover plate 130. The weight of the battery module 10 may be used to seal the space between the first tray 210 and the second tray 220, enhancing the sealing effect and effectively preventing or suppressing gas from escaping into the space between the cover plate 130 and the first tray 210 after escaping through the vent holes H. For example, when the battery pack 1 is mounted on a lower side of an electric vehicle, venting gas downward may improve occupant safety.

Without requiring additional joining processes such as welding among the battery module accommodation portion 211, the cover plate 130, and the module frame 120, the battery module 10 may be seated or fixed in the battery module accommodation portion 211 simply by inserting the cover plate 130 into the battery module accommodation portion 211 and inserting the module frame 120 into the cover plate 130. The portion of the module frame 120 inserted into the cover plate 130 may be supported on its outer surface by the cover plate 130, and the cover plate 130 may be supported by the first tray 210, thereby allowing the module frame 120 to be doubly supported. For example, structural characteristics among the battery module accommodation portion 211, the cover plate 130, and the module frame 120 alone may ensure structural stability that allows the battery module 10 to be seated or fixed in the battery module accommodation portion 211 without adding welding processes or increasing material rigidity. With this structural stability, even if swelling of the battery cells 110 expands the interior of the module frame 120, deformation of the module frame 120 may be minimized, thereby suppressing swelling. Referring again to FIGS. 4 to 7, the module frame 120 may include a base plate 121 and a plurality of side plates 123.

The base plate 121 and the plurality of side plates 123 may be integrally formed through a pressing process.

The base plate 121 may be provided opposite the cover plate 130. The base plate 121 may include fixing portions F. The fixing portions F may be provided at corner portions or in an outer region of the base plate 121 so as not to overlap the battery cells 110 along the height direction (Z-axis direction). The fixing portions F may be formed by a drawing process. The fixing portions F may be formed on the base plate 121 by pressing the plate-shaped base plate 121 against a die having an internal shape corresponding to the fixing portions F. The fixing portions F may be configured to allow fastening members S2 to be inserted therethrough. The fastening members S2 may be inserted through the fixing portions F to couple the module frame 120, the cover plate 130, and the pack frame 20.

The plurality of side plates 123 may be connected to the base plate 121. The plurality of side plates 123 may cover side surfaces of the battery module 10. The plurality of side plates 123 may include two first side plates 123a and two second side plates 123b. The two first side plates 123a may be disposed opposite to each other. The two second side plates 123b may be disposed opposite to each other between the two first side plates 123a. The two first side plates 123a may be coupled to the two second side plates 123b. Each end of the first side plates 123a may be bent toward a corresponding one of the second side plates 123b and may include a coupling portion 125 overlapping the corresponding second side plate 123b. The coupling portions 125 may be coupled to the second side plates 123b by fastening members S1. Alternatively, the coupling portions 125 may be welded to the second side plates 123b. Alternatively, the coupling portions 125 may be clinched to the second side plates 123b. In another embodiment, the coupling portions 125 may be formed at respective ends of the second side plates 123b to be coupled to the first side plates 123a. The plurality of side plates 123 may be inserted into and fitted into an inner surface of the insertion portion 131, allowing the module frame 120 to be coupled to the cover plate 130.

According to the configuration of the present disclosure described above, since there is no need to add a separate member for coupling the battery module 10 to the pack frame 20, the manufacturing cost of the battery pack 1 may be reduced, and the manufacturing process may be simplified. For example, by integrally providing the fixing portions F on the base plate 121, the battery module 10 may be coupled to the pack frame 20, simply by inserting fastening members S2 into the fixing portions F after coupling the base plate 121 and the side plates 123, without requiring any additional processes. In addition, when the fixing portions F are formed on the base plate 121 by a drawing process, the manufacturing method may be further simplified.

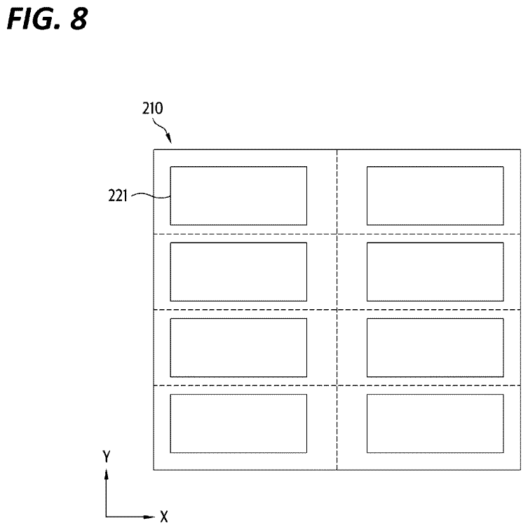

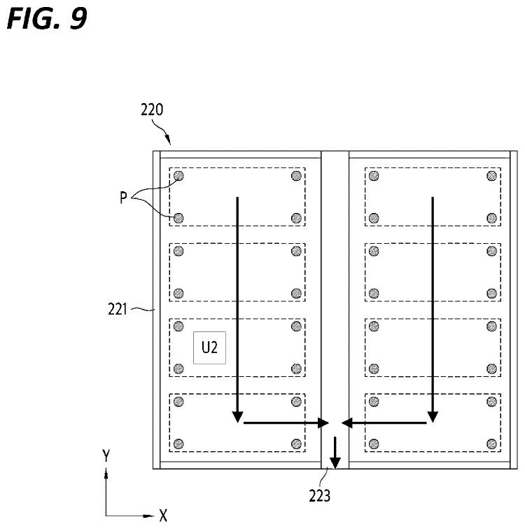

FIG. 8 is a view illustrating a first tray 210 included in a pack frame 20 according to an embodiment of the present disclosure. FIG. 9 is a view illustrating a second tray 220 included in the pack frame 20 according to an embodiment of the present disclosure.

Referring to FIGS. 8 and 9, the pack frame 20 may include a first tray 210 and a second tray 220.

The first tray 210 may include battery module accommodation portions 211. The first tray 210 may be provided with a number of battery module accommodation portions 211 corresponding to the number of battery modules 10. The first tray 210 may have a plate shape, and in the plate, the battery module accommodation portions 211 may form a shape corresponding to a lower shape of the battery modules 10, for example, a rectangular opening. Referring also to FIG. 7, the first tray 210 may further include reinforcement portions 213 extending from the battery module accommodation portions 211 toward the second tray 220 and configured to support side surfaces of the cover plates 130.

The second tray 220 may be disposed apart from the first tray 210 and the battery modules 10. The second tray 220 may include support pillars P protruding toward the first tray 210 on a surface facing the first tray 210. The support pillars P may support a lower surface of the cover plates 130. The support pillars P may be provided at corner portions or in an outer region of the cover plates 130 to support an area that does not overlap with the battery cells 110 along the height direction (Z-axis direction). Referring also to FIG. 7, fastening members S2 inserted through the fixing portions F may be coupled to the support pillars P, thereby coupling the module frames 120, the cover plates 130, and the pack frame 20 together. The second tray 220 may include side beams 221 and a center beam 223 that support the first tray 210 and partition a space.

With this configuration of the present disclosure, even without a separate member for fixing the battery modules 10, the insertion portions 131 of the cover plates 130 may be inserted into the battery module accommodation portions 211, and the support portions 133 of the cover plates 130 may be engaged with and supported on the first tray 210, allowing the battery modules 10 to be fixedly seated in the pack frame 20. When the support pillars P are provided, the battery modules 10 may be effectively seated in the pack frame 20. When the fastening members S2 are coupled to the support pillars P through the fixing portions F, the battery modules 10 may be effectively fixed to the pack frame 20.

By forming the battery module accommodation portions 211 of the first tray 210 as openings, the accommodation portions 211 may not only serve to fix the battery modules 10 but also allow the vent holes H of the battery modules 10 to directly communicate with venting paths U.

The venting paths U, configured to allow gas generated from the battery cells 110 to flow therethrough, may be provided between the first tray 210 and the second tray 220. Referring also to FIG. 7, the venting paths U may include a first path U1 through which the gas flows between the first tray 210 and the second tray 220 inside each battery module 10, and a second path U2 through which the gas flows between regions corresponding to adjacent battery modules 10. The gas flowing along the first path U1 may flow in two rows along the second path U2 in the spaces partitioned by the side beams 221 and the center beam 223, and may then flow into an internal space of the center beam 223 through a vent hole (not illustrated) or a venting device (not illustrated) provided at an end of the center beam 223. According to an embodiment, the internal space of the center beam 223 may be connected to a venting device D (see FIG. 1) of the pack frame 20, allowing the gas to be discharged to the outside of the battery pack 1.

The battery pack 1 may further include a pack cover C and a heat sink (not illustrated). The pack cover C (see FIG. 1) may cover the pack frame 20. The pack cover C may cover the open side of the pack frame 20. The heat sink may be disposed on an opposite side of the battery module accommodation portions 211 relative to the battery modules 10. For example, the heat sink may be provided between the battery modules 10 and the pack cover C. The heat sink may be configured to perform heat exchange with the battery modules 10 based on a cooling medium flowing therein. For example, the cooling medium may be introduced into the interior of the heat sink from the outside in a cooled state, may flow through a predetermined flow path provided inside the heat sink while being heated by heat conducted from the battery modules 10, and may then be discharged back to the outside. The cooling medium may then be cooled again externally, introduced back into the interior of the heat sink, and flow through the predetermined flow path provided inside, exchanging heat with the battery modules 10 before being discharged, thereby forming a circulation structure.

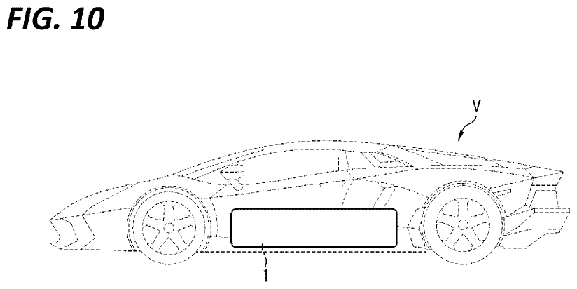

FIG. 10 is a view illustrating a vehicle V according to an embodiment of the present disclosure.

Referring to FIG. 10, the vehicle V according to the present disclosure may include a battery pack 1 according to the present disclosure. The vehicle V may further include various other components in addition to the battery pack 1. For example, the vehicle V according to the present disclosure may further include a vehicle body, a motor, a control unit such as an electronic control unit (ECU), in addition to the battery pack 1 according to the present disclosure.

As described above, the present disclosure has been described with reference to the accompanying drawings focusing on embodiments, but it will be apparent to those ordinarily skilled in the art that numerous modifications are possible without departing from the scope of the present disclosure. Accordingly, the scope of the present disclosure should be interpreted based on the claims, which are intended to cover such numerous modifications.

What is claimed is:

1. A battery pack comprising:
a battery cell;
a battery module including a module frame configured to have one side open and to accommodate the battery cell, and a cover plate configured to cover the open side of the module frame; and
a pack frame including a battery module accommodation portion into which the battery module is inserted and configured to accommodate the battery module.

2. The battery pack according to claim 1, wherein the pack frame includes a first tray having the battery module accommodation portion and a second tray disposed apart from the first tray and the battery module.

3. The battery pack according to claim 2, wherein the first tray further includes a reinforcement portion extending from the battery module accommodation portion toward the second tray and configured to support a side surface of the cover plate.

4. The battery pack according to claim 2, wherein a venting path configured to allow gas generated from the battery cell to flow is provided between the first tray and the second tray.

5. The battery pack according to claim 2, wherein the second tray includes a support pillar protruding toward the first tray on a surface facing the first tray and configured to support a lower surface of the cover plate.

6. The battery pack according to claim 5, wherein the support pillars support a corner portion of the cover plate.

7. The battery pack according to claim 1, wherein the cover plate includes an insertion portion inserted into the battery module accommodation portion of the pack frame, and a support portion extending from the insertion portion and configured to be engaged with and supported on the pack frame.

8. The battery pack according to claim 7, wherein an end portion of the open side of the module frame is inserted into an inner surface of the insertion portion.

9. The battery pack according to claim 7, wherein the module frame includes a base plate provided opposite to the cover plate and a plurality of side plates connected to the base plate and configured to cover side surfaces of the battery cells,
the plurality of side plates include two first side plates disposed opposite to each other and two second side plates disposed opposite to each other between the two first side plates, and
the two first side plates are coupled to the two second side plates through fastening members.

10. The battery pack according to claim 1, wherein the battery pack further includes a heat sink disposed on a side opposite to the battery module accommodation portion with respect to the battery module.

11. The battery pack according to claim 1, wherein the cover plate includes a vent hole configured to discharge gas generated from the battery cell.

12. A battery pack comprising:
a battery cell;
a battery module configured to accommodate the battery cell and having a vent hole on one side surface;
a first tray configured to define an opening to accommodate the battery module such that the opening is in communication with the vent hole of the battery module; and
a second tray disposed apart from the first tray.

13. The battery pack according to claim 12, wherein the vent hole of the battery module is disposed to face a lower side of the battery pack.

14. The battery pack according to claim 12, wherein a venting path configured to allow gas generated from the battery cell to flow is provided between the first tray and the second tray.

15. A vehicle comprising the battery pack according to claim 1.

16. A pack frame comprising:
a battery module accommodation portion configured to receive a battery module;
a first tray provided with the battery module accommodation portion; and
a second tray disposed apart from the first tray and the battery module.

17. The pack frame according to claim 16, wherein the first tray further includes a reinforcement portion extending from the battery module accommodation portion toward the second tray and configured to support a side surface of the battery module.

18. The pack frame according to claim 16, wherein a venting path configured to allow gas generated from the battery module to flow therethrough is provided between the first tray and the second tray.

19. The pack frame according to claim 16, wherein the second tray includes a support pillar protruding toward the first tray on a surface facing the first tray and configured to support a lower surface of the battery module.

20. The pack frame according to claim 19, wherein the support pillar supports a corner portion of the lower surface of the battery module.
